(19) United States
(12) Patent Application Publication
(10) Pub. No.: US 2023/0288029 A1
(43) Pub. Date: Sep. 14, 2023

(54) SYSTEM FOR CAPTURING VAPOR FROM A CRYOGENIC STORAGE TANK

(71) Applicant: Sumitomo (SHI) Cryogenics of America, Inc., Allentown, PA (US)

(72) Inventors: Stephen B. DUNN, Bethlehem, PA (US); Ralph C. LONGSWORTH, Bar Harbor, ME (US)

(73) Assignee: Sumitomo (SHI) Cryogenics of America, Inc., Allentown, PA (US)

(21) Appl. No.: 18/116,649

(22) Filed: Mar. 2, 2023

Related U.S. Application Data
(60) Provisional application No. 63/318,555, filed on Mar. 10, 2022.

(51) Int. Cl. F17C 9/02

(52) U.S. Cl. CPC F17C 9/02; F17C 2223/0161; F17C 2265/034; F17C 2227/0353; F17C 2221/017; F17C 2221/012; F17C 2221/011; F17C 2221/014; F17C 2221/016; F17C 2205/0323; F17C 2227/0135; F17C 2201/0109

(57) ABSTRACT

A recovery cryostat, external to a cryogen storage tank, uses a cryocooler to condense vapor of cryogen from the storage tank and return the cryogen to the storage tank as a liquid. The process may be continuous or cyclical depending on the orientation of the recovery cryostat. If the recovery cryostat is located such that liquid can drain back to the storage tank, the process can be continuous. If the liquid cannot be drained back, a valve on the liquid return line is closed while the cryocooler condenses the vapor, a valve on the vapor supply line is then closed, the valve on the liquid return line is opened, and pressure in the recovery cryostat is increased to drive the liquid out. The storage tank is a type that can have vapor that boils off external to the tank be returned to the vapor space above the liquid in the tank.

### CROSS REFERENCE TO RELATED APPLICATIONS

This application claims priority to U.S. Provisional Patent Application No. 63/318,555, filed Mar. 10, 2022, the entire contents of which are incorporated herein by reference.

### BACKGROUND OF THE INVENTION

### Field of Invention

This invention relates to cryogenic storage tank operation for storing liquid cryogens and preventing the loss of vaporized cryogen.

### Background

Cryogenic gases used commercially, including nitrogen, oxygen, hydrogen, and helium, are often transported and stored in their liquid state, at relatively cold temperatures (less than −175° C.). Because of the cold temperature and presence of both liquid and vapor phases, special handling is required. However, the greater density and lower pressure make it economically advantageous to handle these cryogens as liquids instead of gases. While the recovery methods included in this description may be applied to all cryogenic storage tanks, the near term application is for hydrogen storage tanks used in refueling vehicles. Hydrogen is being stored on vehicles in three ways at the present time: first as high pressure gas in bottles at pressure as high as about 700 MPa (10,500 psi), second as a hydride in bottles at a lower pressure, and third as a liquid at pressures near atmospheric pressure. The lower the pressure of a cryogenic liquid tank, the greater the density of the liquid and the lighter the weight of the tank; but the cost of cooling to a lower temperature increases the cost of cooling the cryogen. Hydrogen fueling stations that deliver gas at a high pressure use a pump that compresses the liquid to a high pressure then warm it to ambient temperature in a vaporizer and store it in high pressure gas cylinders. The liquid pumps are operated intermittently and warm up between uses, thus generating a lot of vapor as they are cooled down. Hydrogen fuel stations that refill liquid storage tanks transfer the liquid through vacuum jacketed transfer lines that vaporize the initial flow of liquid as the lines cool down. In both of these systems the vapor can be returned to the top of the storage tank which results in an increase in pressure; the increase depending on the amount of vapor relative to the size of the tank, the fraction of liquid in the tank, etc. These systems have to be designed and operated to keep within limits that avoid unnecessary venting of hydrogen. These cryogen storage tanks are typically operated with only the vapor of the cryogen in the space above the liquid—the vapor and liquid being in equilibrium. Specifically, the top layer of liquid next to the vapor has the temperature and pressure that is the saturation temperature and saturation pressure associated with the pressure of the vapor above the liquid. Cryogenic liquids become denser as they are cooled so the liquid becomes stratified, with the coldest liquid on the bottom. Similarly the warmest vapor is at the top of the tank. Sometimes, for an operating purpose, the pressure in the tank is temporarily raised by introducing additional gas (vapor) above the liquid. When this is done, some of the vapor condenses into the top layer of liquid, raising its temperature to the new, higher saturation temperature, but leaving the lower layers of liquid at approximately their original temperature and therefore, even more sub-cooled relative to the new, higher pressure.

During storage, a small amount of heat (heat leak) passes through the tank insulation and vaporizes some of the liquid cryogen, building pressure in the tank. Cryogen storage tanks that transport liquid cryogens are sealed during transport and the pressure is allowed to rise until the cryogen is delivered, or vented through a pressure relief valve. This is also typical of storage tanks that deliver the cryogen intermittently. Liquid is typically delivered from a storage tank by one of three methods. The first is to extend a line (tube) from the bottom of the tank through the top of the tank and forcing the liquid out by having the pressure above the liquid be greater than the delivered pressure. The second is to use a small pump in the bottom of the tank connected to a line (tube) from the bottom of the tank through the top of the tank and pumping the liquid out. The third is to have a line at the bottom of the tank that allows the liquid cryogen to drain out by the force of gravity or possibly be assisted by a pump. This invention applies to the second and third types of storage tanks in which vapor that results from cooling down objects outside the storage tank can be returned as gas to the top of the tank and if it is, it can then flow to a recovery cryostat external to the storage tank, be cooled down, condensed, and returned to the storage tank as liquid.

Existing systems that use a liquid hydrogen storage tank and deliver hydrogen gas at high pressure recover the boil off gas from cooling down the liquid pump by returning the boil off gas to the storage tank, taking gas from the storage tank and warming it to near ambient temperature, then processing it through a high pressure compressor. The volume of gas is minimized by operating the storage tank near the critical pressure, but even so the compressor is inefficient compared to the liquid pump because the volume of gas entering the compressor at 270 K and 0.6 MPa is over 100 times that of liquid entering the cold pump at the same pressure and mass flow rate. The compressibility of the liquid is much less than the gas which means that the clearance volume in the compressor can be much less; requiring the use of a diaphragm compressor rather than a less expensive piston type compressor. The cryogenic recovery cryostat of this invention can replace the gas compressor.

Cryostats that are designed to keep objects such as magnetic resonance imaging (MRI) magnets cold typically have a Gifford-McMahon (GM) type cryogenic expander mounted in a neck tube at the top of the magnet that cools a radiation shield at a first stage temperature e.g. 50 K and a second stage that re-condenses helium boil off at about 4 K. U.S. Pat. No. 7,434,407 describes the use of a Stirling type pulse tube refrigerator to cool a hydrogen storage tank, using the first stage to cool a cold shield and the second stage to keep liquid hydrogen (H₂) from boiling off. Heat is transferred from the storage tank to the refrigerator by circulating helium through tubes wrapped independently around the cold shield and inner tank, and cooling the helium in the tubing on the first and second stages of the refrigerator. The application that is described is its use as a liquid hydrogen fuel container on a vehicle. U.S. Pat. No. 7,165,408 describes a method of operating a liquid hydrogen storage tank, designed for use in an automobile, which minimizes the amount of gas that vents between refilling the tank. The patent has interesting descriptions of the changes in pressure and density with time.

### SUMMARY

The disclosed invention provides cryogenic systems and methods for the recovery of gas that vaporizes when a liquid cryogen flows from a cryogenic storage tank as it cools down an external mass. The storage tank is a type that has liquid flow from the tank by force of gravity or by being pumped, and in which the vaporized gas can be returned to the vapor space above the liquid in the storage tank. The system of the disclosed invention comprises a recovery cryostat external to the storage tank, which uses a cryocooler to condense vapor received from the storage tank and to return it to the storage tank as a liquid. The process may be continuous or cyclical depending on the orientation of the recovery cryostat. If the recovery cryostat is located such that liquid can drain back to the storage tank, then the process can be continuous. If the liquid cannot be drained back, then a valve on the liquid return line is closed while the cryocooler condenses the vapor, a valve on the vapor supply line is then closed, the valve on the liquid return line is opened, and pressure in the recovery cryostat is increased to drive the liquid out.

These advantages and others are achieved, for example, by a cryogenic system for condensing vapor of cryogen from a cryogenic storage tank in an external recovery cryostat and returning the cryogen to the storage tank as a liquid. The cryogenic system includes a storage tank and a recovery cryostat connected to the storage tank. The storage tank is configured to store a liquid cryogen and to deliver the liquid cryogen to an external component. The storage tank is also configured to receive vapor from the liquid cryogen that boils off when said external component and connecting lines are cooled down. The recovery cryostat is configured to receive vapor from the storage tank through a gas line, is coupled to a cryocooler that is configured to condense the vapor received from the storage tank into liquid, and is configured to return the liquid to the storage tank through a liquid line.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 shows a schematic diagram of embodiment which adds to a cryogen storage tank an external recovery cryostat containing a cryocooler. Lines are shown that supply liquid to a pump, return vapor from cooling down the pump to the storage tank, and connect vapor supply and liquid return lines to the recovery cryostat.

FIG. 2 shows a schematic diagram of embodiment which adds to a cryogen storage tank an external recovery cryostat containing a cryocooler. Lines are shown that supply liquid to a liquid container, return vapor from cooling down and filling the container to the storage tank, and connect vapor supply and liquid return lines to the recovery cryostat.

FIG. 3 shows a schematic diagram of embodiment which has a vapor cooled heat shield in a cryogenic storage tank and an external recovery cryostat containing a cryocooler. Lines are shown that supply liquid to a pump, return vapor from cooling down the pump to the storage tank, and connect a vapor supply line (through the heat shield) and a liquid return line to the recovery cryostat.

FIG. 4 shows a workflow diagram for an embodiment of a method to recover vapor that boils off in a cryogenic system.

FIG. 5 shows a workflow diagram for another embodiment of a method to recover vapor that boils off in a cryogenic system.

### DETAILED DESCRIPTION

In this section, some embodiments of the invention will be described more fully with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will convey the scope of the invention to those skilled in the art. Parts that are the same or similar in the drawings have the same numbers and descriptions are usually not repeated.

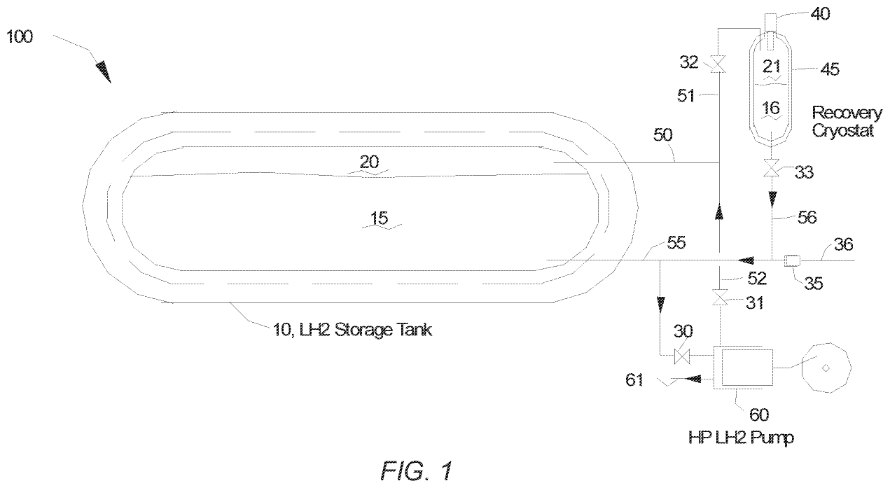

With reference to FIG. 1, shown is a preferred embodiment of cryogenic system 100 that is configured to store cryogen in a storage tank and to capture vapor from the storage tank. The cryogen may include one of helium, hydrogen, neon, oxygen, nitrogen, and argon. All components shown are insulated according to existing practice to minimize heat entering the cryogen from the exterior environment. Cryogen storage tank 10 contains liquid cryogen 15 and vapor cryogen 20. Recovery cryostat 45 has cryocooler 40 mounted at its top where it condenses vapor 20 that flows through gas lines 50, 51 and can be blocked by gas line supply valve 32. Reference numeral 16 refers to the liquid that collects in recovery cryostat 45, and reference numeral 21 refers to the vapor above the liquid 16. Liquid 16 returns to storage tank 10 through liquid lines 56, 55, and can be blocked by liquid line return valve 33 in line 56. Storage tank 10 is refilled through line 36 from a delivery trailer and removable coupling 35. The recovery cryostat 45 may be located above the storage tank 10 such that the condensed liquid 16 can be returned to the storage tank by gravity.

Pump 60 is used intermittently and warms up between uses. It is provided as an example of equipment that may be used with the present invention. Before pump 60 can be turned on to pump liquid cryogen, it must be cooled down to the liquid temperature. To remove the sensible heat of pump 60, valve 33 is closed and valves 30 and 31 are opened. Liquid cryogen 15 is shown flowing to pump 60 by gravity through pipes 55 and valve 30. As long as the pump is warmer than the liquid, the sensible heat of pump 60 vaporizes the liquid. The vapor flows through valve 31 and line 52, then splits. Most or all of the vapor returns to storage tank 10 through line 50. Some may flow through line 51 and valve 32 into recovery cryostat 45. The warm gas that collects at the top of storage tank 10 increases the pressure in the tank, causing liquid 15 to become subcooled.

The cool down vaporization continues until the pump is cooled to the saturation temperature of the liquid. Then the pump can be operated, pumping liquid to higher pressure through discharge line 61. Removing liquid from tank 10 causes vapor 20 to expand, dropping in pressure and temperature. If a lot of liquid is removed, the pressure at the inlet to the pump 60 will drop to the point where the cryogen will start to boil and the pump has to be turned off. For batch removal of cryogen from a large storage tank, pump 60 is turned off before this happens. After pump 60 is turned off the valve settings are returned to the positions they were in before the pump was turned on.

Cryocooler 40 is designed to provide slightly more refrigeration than required to match the average heat losses over an extended period of time and is usually insufficient to condense the gas at the rate it is generated by cooling down the pump. Cryocooler 40 is coupled or attached to cryostat 45 to cool down the vapor 21 in the cryostat 45. Cryocooler 40 may be one of a GM, pulse tube, Stirling, or reverse Brayton type of cryocooler. The size of cryocooler 40 is selected to condense gas that vaporizes due to heat leak, and that required to keep storage tank 10 below a pressure that would cause a safety vent valve (not shown) to vent some of the cryogen. The size of recovery cryostat 45 is selected to store condensed cryogen between time intervals when it is returned to storage tank 10.

If recovery cryostat 45 is located such that liquid can drain back to the storage tank, then valves 32 and 33 may not be needed or may be always at open positions and the condensing process may be continuous. If the liquid cannot be drained back, then valve 33 on liquid return line 56 is closed while cryocooler 40 condenses the vapor. When conditions are reached for returning liquid, valve 32 on the vapor supply line 51 is closed. Pressure in recovery cryostat 45 is then increased sufficiently to force the liquid out through valve 33, which may be a check valve. How much the pressure in cryostat 45 has to exceed in recovery cryostat 45 depends on the difference in elevation between the liquid surfaces and the pressure drop at the desired flow rate through valve 33 and lines 56 and 55. This process typically takes place while valves 30 and 31 are closed, but may take place while one or both are open. If valve 30 is open, the pressure needed to supply liquid direct to the external component (for example, pump 60) will be less than that needed to return liquid to storage tank 10. The pressure in cryostat 45 may be increased by turning off the cryocooler 40, turning on a heater (not shown) in cryostat 45, or pressurizing cryostat 45 with the same gas as the vapor. If storage tank 10 is the type that has a pump to deliver liquid, the pump is usually an impeller type that would allow liquid to flow through it in reverse when it is not running.

An example is given for a storage tank 10 that can hold 80,000 L of hydrogen, and a liquid pump 60, that requires the removal of 2,000 kJ to cool from 160 K to 28 K, the saturation temperature at the surface of the liquid. Cooling the pump requires 4.0 kg of liquid hydrogen which has a vapor volume of 1,700 L, assuming the vapor leaves pump 60, as it cools down, at its temperature and at the saturation pressure corresponding to 28 K, 587 kPa. This is less than 3% of the volume of storage tank 10 and results in a pressure increase in the tank of less than 100 kPa if the tank is 85% full of liquid. Cryocooler 40 on recovery cryostat 45 has to provide enough cooling to match the heat loss in a hydrogen storage tank, typically less than 40 W for this size tank, condensing the boil-off gas, 2,000 kJ, and other losses in the lines and recovery cryostat estimated at 25 W. If liquid pump 60 is operated every 6 hours, the load is 93 W to remove 2,000 kJ of heat, thus the total load on the cryocooler 40 is about 160 W at about 28 K. If this example is applied to a hydrogen refueling station, the time interval between cooling down the pump might be shorter during the day and longer at night so the average pressure in the storage tank might increase during the day and decrease at night.

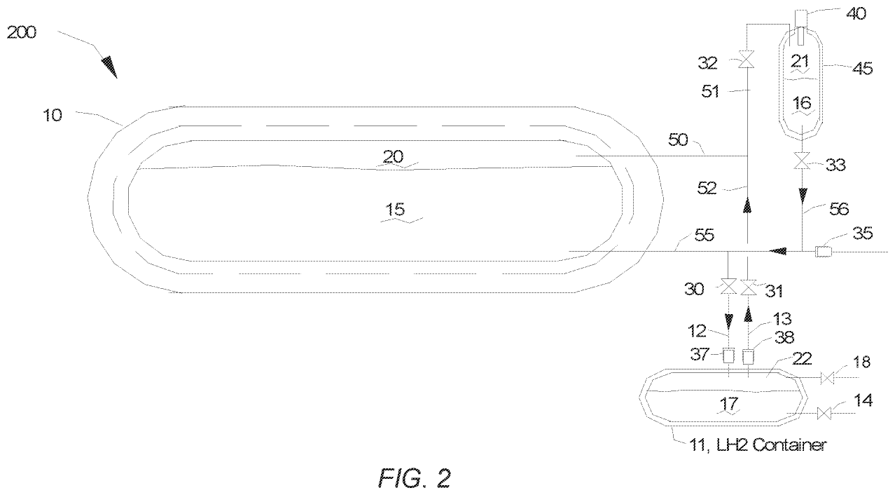

With reference to FIG. 2, shown is an embodiment of cryogenic system 200 that includes a liquid container instead of a pump. While system 100 represents an application that favors a pressure in storage tank 10 near the critical pressure, cryogenic system 200 shown in FIG. 2 represents an application that favors a pressure near atmospheric pressure. The application is the filling/refilling of a cryogenic container which is illustrated by liquid hydrogen container 11, examples of which are described in U.S. Pat. Nos. 7,434,407 and 7,165,408. Both of these patents describe liquid hydrogen containers that can be used in vehicles. Lines 12 and 13 are vacuum insulated and connected to removable couplings 37 and 38 respectively on container 11. Container 11 is filled by opening valves 30 and 31 allowing liquid to flow into container 11 through line 55, valve 30, line 12 and coupling 37. The vapor that results from cooling down the lines, and possibly container 11 as well as the vapor 22 displaced as liquid 17 filling the container 11 is returned to the top of storage tank 10 through coupling 38, line 13, valve 31, and lines 52 and 50. After container 11 has been filled, valves 30 and 31 are closed and the vapor that has been returned to storage tank 10 and recovery cryostat 45 is condensed and returned to storage tank 10, the same as in system 100. Hydrogen can flow out from container 11 as a liquid through valve 14 and can flow in or out as a gas through valve 18.

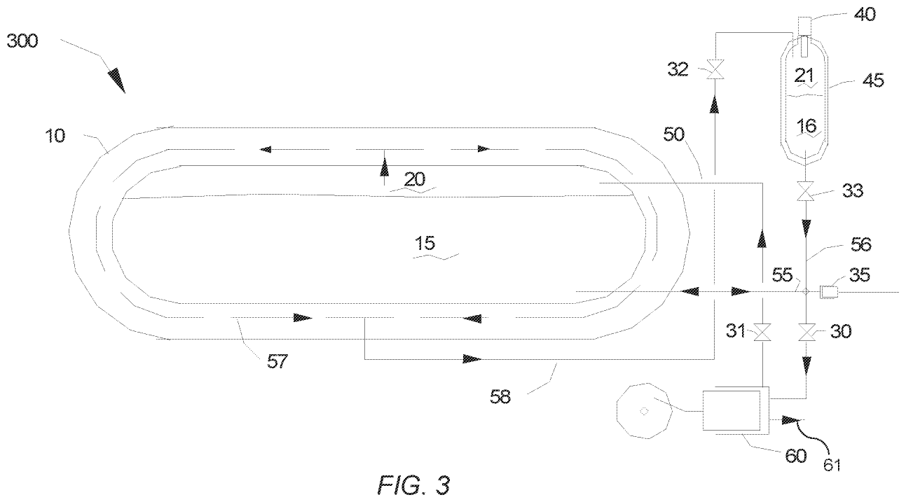

With reference to FIG. 3, shown is an embodiment of cryogenic system 300 which is a variation of cryogenic system 100. Some cryogenic storage tanks use boil-off vapor to flow through a line 57 that cools a cold shield to intercept heat leak into the liquid, then allowing it to be vented. System 300 recovers this gas by flowing the gas, after it leaves storage tank 10, through line 58, through valve 32, and into recovery cryostat 45. Cool down of an external component, such as liquid pump 60 or filling container 11, proceeds as described for system 100 and 200. The difference from these systems is that during the time when valves 30 and 31 are closed, vapor 20 exits storage tank 10 through lines 57 and 58, rather than line 50, as it flows to recovery cryostat 45. Liquid 16 is returned to storage tank 10 as described for system 100. Liquid hydrogen can alternately flow through valve 30 to liquid hydrogen container 11 and return as gas through valve 31 as described for system 200.

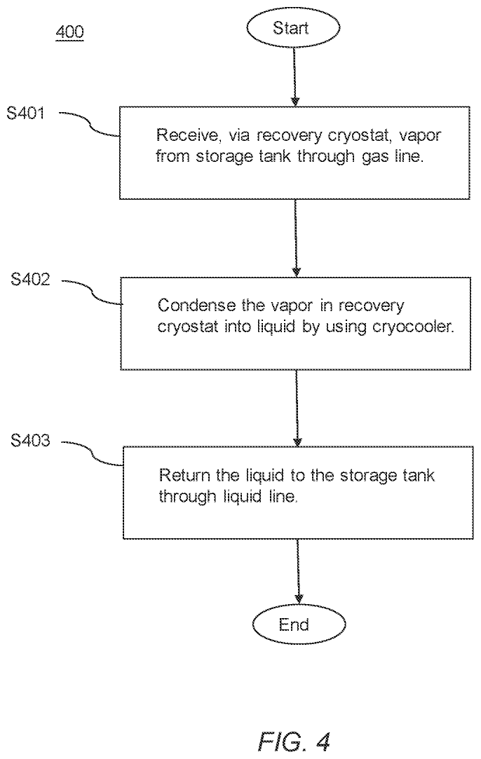

With reference to FIG. 4, shown is a workflow diagram for a method 400 which uses recovery cryostat 45 to recover vapor that boils off in a cryogenic system. The method 400 may be used with any of cryogenic systems 100, 200, 300 described above. The method 400 may be used in the situation that recovery cryostat 45 is located such that liquid can drain back to the storage tank and the condensing process can be continuous. For example, storage tank 10 may be configured to deliver a liquid cryogen to an external component by force of gravity and recovery cryostat 45 may be configured to return condensed liquid by force of gravity to the storage tank 10 through a liquid line 55, 56. The method 400 includes steps of receiving, via the recovery cryostat 45, the vapor from the storage tank 10 through the gas line 50, 51, block S401, condensing the vapor 21 into the liquid 16 by using the cryocooler 40, block S402, and returning the liquid 16 to the storage tank 10 through the liquid line 55, 56, block S403.

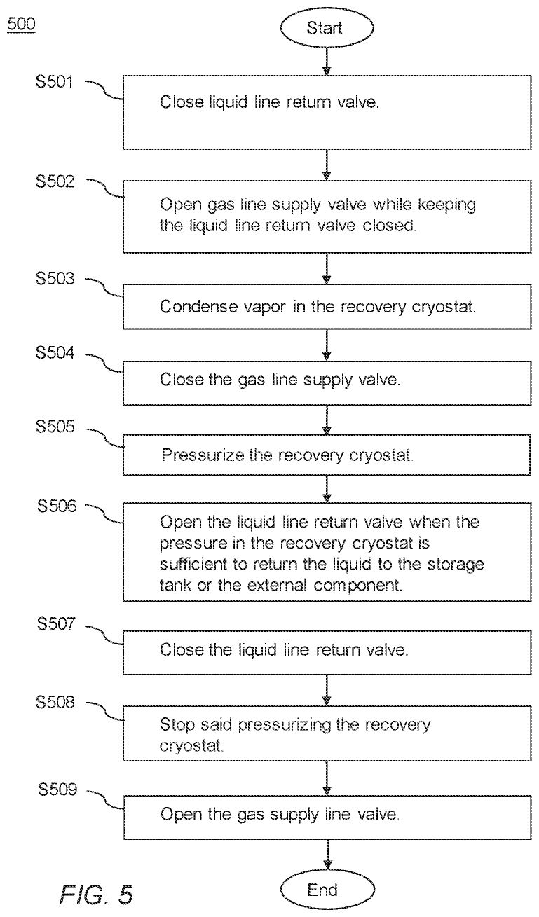

With reference to FIG. 5, shown is a workflow diagram for a method 500, which uses recovery cryostat 45 to recover vapor that boils off in a cryogenic system. The method 500 may be used with any of cryogenic systems 100, 200, 300 described above. The method 500 may be used in the situation that storage tank 10 is configured to deliver a liquid cryogen to an external component. The method 500 includes steps of closing liquid line return valve 33, block S501, opening the gas line supply valve 32 while keeping the liquid line return valve 33 closed, block S502, condensing the vapor 21 in the recovery cryostat 45, block S503, closing the gas line supply valve 32, block S504, pressurizing the recovery cryostat 45, block S505, by one or more of turning off the cryocooler 40, turning on a heater (not shown) in the recovery cryostat 45, and pressurizing the recovery cryostat 45 with the same gas as the vapor, opening the liquid line return valve 33 when the pressure in the recovery cryostat 45 is sufficient to return the liquid 16 to the storage tank 10 or the external component, block S506, closing the liquid line return valve 33, block S507, stopping pressurizing the recovery cryostat 45, block S508, by reversing the pressurizing process of the step S505, and opening the gas supply line valve 32, block S509.

The terms and descriptions used herein are set forth by way of illustration only and are not meant as limitations. Those skilled in the art will recognize that many variations are possible within the spirit and scope of the invention and the embodiments described herein.

What is claimed is:

1. A cryogenic system for condensing vapor of cryogen from a cryogenic storage tank in an external recovery cryostat and returning the cryogen to the storage tank as a liquid, comprising:
a storage tank that is configured to store a liquid cryogen and to deliver the liquid cryogen to an external component, said storage tank configured to receive vapor from the liquid cryogen that boils off when said external component and connecting lines are cooled down; and
a recovery cryostat connected to said storage tank, wherein the recovery cryostat is configured to receive vapor from the storage tank through a gas line, is coupled to a cryocooler that is configured to condense the vapor received from said storage tank into liquid, and is configured to return the liquid to said storage tank through a liquid line.

2. The cryogenic system in accordance with claim 1 wherein the cryogen includes one of helium, hydrogen, neon, oxygen, nitrogen, and argon.

3. The cryogenic system in accordance with claim 1 wherein said recovery cryostat is located above said storage tank such that the condensed liquid returns to the storage tank by gravity.

4. The cryogenic system in accordance with claim 1 further comprising:
a supply valve in the gas line that connects the storage tank to the recovery cryostat; and
a return valve in the liquid line that connects the recovery cryostat to the storage tank.

5. The cryogenic system in accordance with claim 1 wherein said external component is one of a liquid pump and a liquid container.

6. The cryogenic system in accordance with claim 1 wherein the cryocooler is one of a GM type cryogenic expander, a pulse tube, a Stirling type pulse tube, and a reverse Brayton type of cryocooler.

7. A method to recover vapor that boils off in a cryogenic system comprising: a storage tank that is configured to deliver a liquid cryogen to an external component by force of gravity, said storage tank configured to receive vapor from the liquid cryogen that boils off when said external component and connecting lines are cooled down; and a recovery cryostat configured to receive vapor from the storage tank through a gas line, coupled to a cryocooler that is configured to condense the vapor received from said storage tank into liquid, and configured to return the liquid by the force of gravity to said storage tank through a liquid line, the method comprising:
receiving, via the recovery cryostat, the vapor from the storage tank through the gas line;
condensing the vapor into the liquid by using the cryocooler; and
returning the liquid to the storage tank through the liquid line.

8. The method in accordance with claim 7 wherein the cryogen is one of helium, hydrogen, neon, oxygen, nitrogen, and argon.

9. The method in accordance with claim 7 wherein said external component is one of a liquid pump and a liquid container.

10. The method in accordance with claim 7 wherein said recovery cryostat is located above said storage tank such that the condensed liquid returns to the storage tank by the force of gravity.

11. The method in accordance with claim 7 wherein the cryogenic system further comprises:
a supply valve in the gas line that connects the storage tank to the recovery cryostat; and
a return valve in the liquid line that connects the recovery cryostat to the storage tank.

12. The method in accordance with claim 7 wherein the cryocooler is one of a GM type cryogenic expander, a pulse tube, a Stirling type pulse tube, and a reverse Brayton type of cryocooler.

13. A method to recover vapor that boils off in a cryogenic system comprising: a storage tank that is configured to deliver a liquid cryogen to an external component, said storage tank configured to receive vapor from the liquid cryogen that boils off when said external component and connecting lines are cooled down; and a recovery cryostat configured to receive vapor from the storage tank through a gas line that has a gas line supply valve, coupled to a cryocooler that is configured to condense the vapor received from said storage tank into liquid, and configured to return the liquid to said storage tank or the external component through a liquid line that has a liquid line return valve, the method comprising:
closing the liquid line return valve;
opening the gas line supply valve while keeping the liquid line return valve closed;
condensing the vapor in the recovery cryostat;
closing the gas line supply valve;
pressurizing the recovery cryostat by one or more of turning off the cryocooler, turning on a heater in the recovery cryostat, and pressurizing the recovery cryostat with the same gas as the vapor;
opening the liquid line return valve based on the pressure in the recovery cryostat to return the liquid to the storage tank or the external component;
closing the liquid line return valve;
stopping said pressurizing the recovery cryostat; and
opening the gas supply line valve.

14. The method in accordance with claim 13 wherein the cryogen is one of helium, hydrogen, neon, oxygen, nitrogen, and argon.

15. The method in accordance with claim 13 in which said external component is one of a liquid pump and a liquid container.

16. The method in accordance with claim 13 wherein said recovery cryostat is located above said storage tank such that the condensed liquid returns to the storage tank by force of gravity.

17. The method in accordance with claim 13 wherein the cryocooler is one of a GM type cryogenic expander, a pulse tube, a Stirling type pulse tube, and a reverse Brayton type of cryocooler.

18. The method in accordance with claim 13 wherein said opening the liquid line return valve comprises opening the liquid line return valve when the pressure in the recovery cryostat is able to force the liquid out through the liquid line.
